(19) United States
(12) Patent Application Publication
(10) Pub. No.: US 2019/0275531 A1
(43) Pub. Date: Sep. 12, 2019

(54) Method for Optimizing a Motor Load During a Shredding Process in a Shredder for Metal Materials

(71) Applicant: Talleres ZB, S.A., Renteria (ES)

(72) Inventor: Adolfo Manzanares Mercero, San Sebastian (ES)

(21) Appl. No.: 16/294,154

(22) Filed: Mar. 6, 2019

(30) Foreign Application Priority Data
Mar. 8, 2018 (ES) P201830223

(51) Int. Cl. B02C 25/00

(52) U.S. Cl. CPC B02C 25/00

(57) ABSTRACT

A method for optimizing a motor load during a shredding process in a shredder for metal materials is provided, wherein the shredder includes a rotor of a mill shredder and a motor with a hydraulic clutch between the rotor and the motor. The method comprises the following steps: measuring a speed of the rotor of the mill using at least one sensor situated on the rotor of the mill; calculating a modified speed based on the measured speed of the rotor, based on a hydraulic sliding of the hydraulic clutch and based on a torque curve of the motor, wherein the torque of the motor is acceptable according to initial calculations within the torque curve of the motor; and applying the modified speed to the motor of the shredder, obtaining the rotational speed that optimizes the motor load during the shredding process.

### CROSS-REFERENCE TO RELATED APPLICATIONS

This application claims priority to Spanish Patent Application No. P201830223 filed Mar. 8, 2018, the disclosure of which is hereby incorporated by reference in its entirety.

### BACKGROUND OF THE INVENTION

### Object of the Invention

The present disclosure relates to a method for optimizing a motor load during a shredding process in a shredder for metal materials, such that the rotational speed of the motor is adjusted as a function of the rotational speed of the rotor of the shredder and as a function of the interaction with the hydraulic clutch that relates the motor to the rotor. The method can be applied to the industry of machinery for recycling and shredding, specifically to the industry of machinery designed for shredding materials, and more specifically to the industry of machinery designed for shredding metal materials.

### Field of the Invention

Currently, shredders for metal materials receive large amounts of material in the shredding chamber, where the shredding mill is located, and this material must be shredded in order for the shredder to continue working. However, feeding the shredding chamber is not done in a uniform way and there are variations in the input of material, thus, shredding in the chamber is not done uniformly or in a consistent way, which leads to excess work or moments in which the shredder works below its shredding potential.

To regulate the workload of the motors for shredders known in the state of the art, the input of metal material to be shredded is usually controlled, and in the case of an excess load, the introduction of the metal material is stopped until the mill is capable of shredding the metal material inside the shredding chamber, at which time metal material is once again introduced in the aforementioned shredding chamber. Occasionally this type of control is entirely manual and causes the motor to be subjected to variations in the workload, and as a result, it sometimes works above its capacity and other times below its capacity. This system of control can also be automatic, the feeding being controlled as a function of the motor load, which is common in shredders.

Furthermore, in shredders for metal materials known in the state of the art, between the motor of the shredder and the rotor of the mill there is a hydraulic clutch with a variable flow that protects the motor and all of the elements situated after the clutch itself when excess power is produced in the motor. For example, when the mill has an excess material load and demands the maximum torque from the motor, the motor will react by providing said torque at an established work speed. If the torque demanded is greater than the maximum torque provided by the motor, the motor could stop (in the case that the clutch is weighted above the demands of the motor), leading to jams in the mill which will require time and resources to solve. In these situations the mill loses efficiency.

The hydraulic clutches known in the state of the art and applied to shredding machines are made up of two facing crowns with vanes, between which a hydraulic fluid circulates, which transmits the movement of one crown to the other, in other words, one crown rotates based on the movement of a motor and the hydraulic fluid transmits the rotational movement of the crown of the motor to a second crown associated with the rotor of the mill of the shredder.

In other words, if there is a difference in speed between the crown associated with the rotor of the mill and the crown associated with the motor of the shredder, said difference in speed is absorbed by the hydraulic clutch by means of the hydraulic sliding of the clutch itself. Specifically, when one crown rotates less than the other one, the hydraulic fluid absorbs the difference in speeds between the crowns.

The hydraulic sliding in the hydraulic clutch generates an increase in the temperature of the hydraulic fluid inside the clutch. This increase in temperature makes it necessary to cool the hydraulic fluid, resulting in a loss of power of the cooling system. Thus, the greater the sliding, the greater the increase in the temperature of the hydraulic fluid, leading to a greater need for cooling, which implies an increase in the loss of power of the system.

In clutches of shredders known in the state of the art, when the motor of the shredder starts up, it does not contain any hydraulic fluid on the inside of the same, meaning the motor starts up idle, and once the working conditions of the motor are reached, the hydraulic fluid is introduced in the clutch in a progressive way. This causes a progressive load of hydraulic fluid in the clutch and a power transfer to the output shaft, where the output pulley is located which in turn transmits the movement to the rotor of the mill. Furthermore, the hydraulic fluid enters and exits the clutch, and when the hydraulic fluid reaches a specific temperature it is necessary to cool the same in order to keep it at a suitable working temperature.

Considering all of the foregoing points, specifically the cooling problem in the hydraulic clutch, for the correct operation of the clutch itself and for the power to be correctly transmitted between the two parts of the clutch, the hydraulic sliding of a clutch is considered optimum when the value thereof is approximately 3%.

The object of this disclosure is a method for optimizing the workload of a motor in a metal shredder that regulates the rotational speed of said motor as a function of the rotational speed of the rotor of the shredder, thereby obtaining a better use of the properties of the motor and reducing the sliding, thereby reducing the power loss of the system.

### SUMMARY OF THE INVENTION

The disclosure teaches a method for optimizing a motor load during a shredding process in a metal shredder, wherein the shredder comprises a rotor of a shredding mill and a motor with a hydraulic clutch between the rotor and the motor.

The method object of the disclosure comprises the following steps:
A. measuring a speed of the rotor of the shredding mill by means of at least a sensor situated on the rotor of the mill.
B. calculating a speed modified based on the speed measured in step A, as based on a hydraulic sliding of the hydraulic clutch and based on a torque curve of the motor, wherein the modified speed provides a torque that is no less than a torque provided in a normal speed regime according to the design of the motor;
C. applying the modified speed to the motor of the shredder obtaining the rotational speed that optimizes the motor load during the shredding process.

In the step of calculating a modified speed based on the speed measured in step A in the method for optimizing a motor during a shredding process in a metal shredder object of the disclosure, the speed that is obtained is the speed of the rotor increased by 3% to 10%.

### BRIEF DESCRIPTION OF THE DRAWINGS

FIG. 1 shows a torque curve of a motor in which the area of the torque curve that is constant is highlighted.

FIG. 2 shows a figure with three curves, in which the upper curve shows the speed of the motor, the middle curve (dashed) shows the motor torque demanded and the lower curve shows the speed of the rotor.

FIG. 3 shows a figure with the curves of the operation of the rotor and the motor, as in those of FIG. 2, but with the system of the disclosure.

### DESCRIPTION OF THE INVENTION

The object of this disclosure is a method for optimizing the motor load during a shredding process in a metal shredder, thereby optimizing the efficiency of the motor, and at the same time reducing the energy dissipated in the form of heat by sliding in the operation of the shredder.

A metal shredder, in a very basic way, comprises a feeding system in which metal materials are fed to the shredder (to which we will not refer in this description given that it is not of interest in the method object of the disclosure), a shredding chamber (which, in turn, comprises a shredding mill that rotates on a rotor, with a plurality of hammers on the periphery of the mill, which on the inside of the chamber thrash the metal material in order to shred it) and an extraction system for the shredded metal material (to which we will not refer in this description given that it is also not of interest in the method object of the disclosure).

The method object of the disclosure is based on continuously controlling the relationship between the speed of the motor of the shredder and the speed of the rotor during the shredding process.

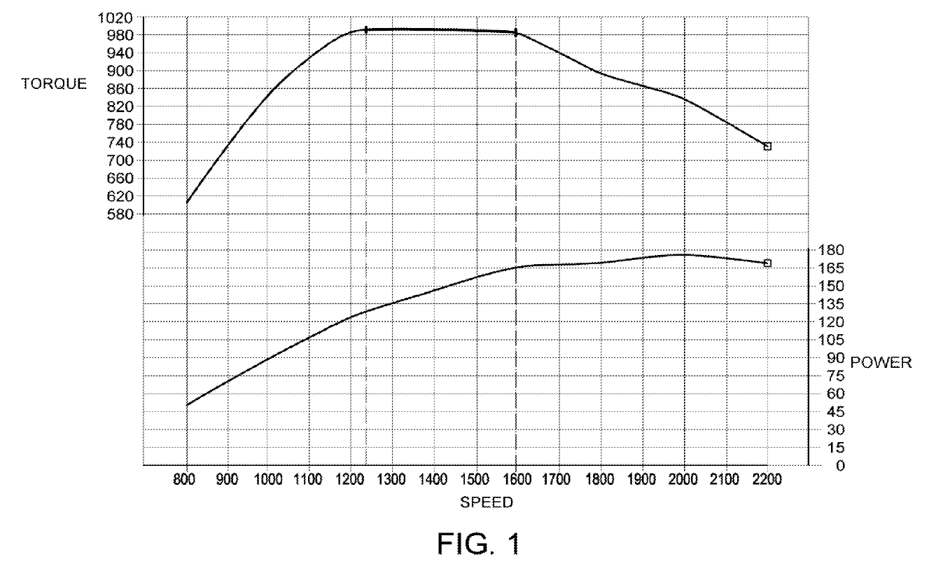

First, to interpret this specification, it would seem appropriate to define the motor load as the motor torque that a motor must supply in order to overcome the resistance that is opposed to the movement thereof, and, as can be seen in FIG. 1, each motor has its own curve which relates the motor torque to the speed of the rotation of the motor.

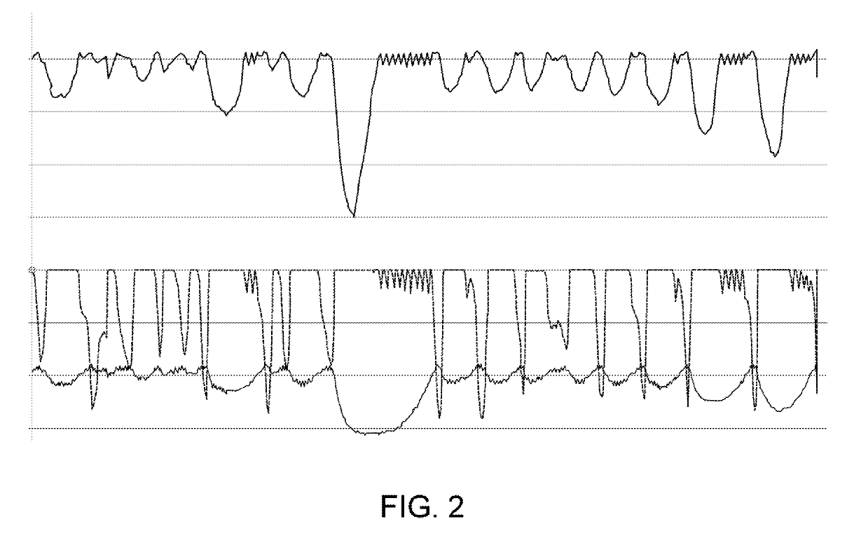

FIG. 2 shows three curves that reflect the behavior of the motor and the rotor in a shredder in which the method object of the disclosure is not carried out, one can see how a reduction in the speed of the rotor (lower curve) is reflected by an increase of the motor torque demanded from the motor (see middle curve in dashed lines), how the reduction of the speed of the rotor drags the motor, the speed of which is also reduced (see upper curve), and how the time that the motor is working at 100% without applying the control object of the disclosure is significant, as can be seen in the middle graph in this curve, all of the time the horizontal part of the same representing the time that the motor is demanded at 100%, which leads to a deterioration of the motor, reducing the useful life of the same and resulting in shorter intervals between maintenance.

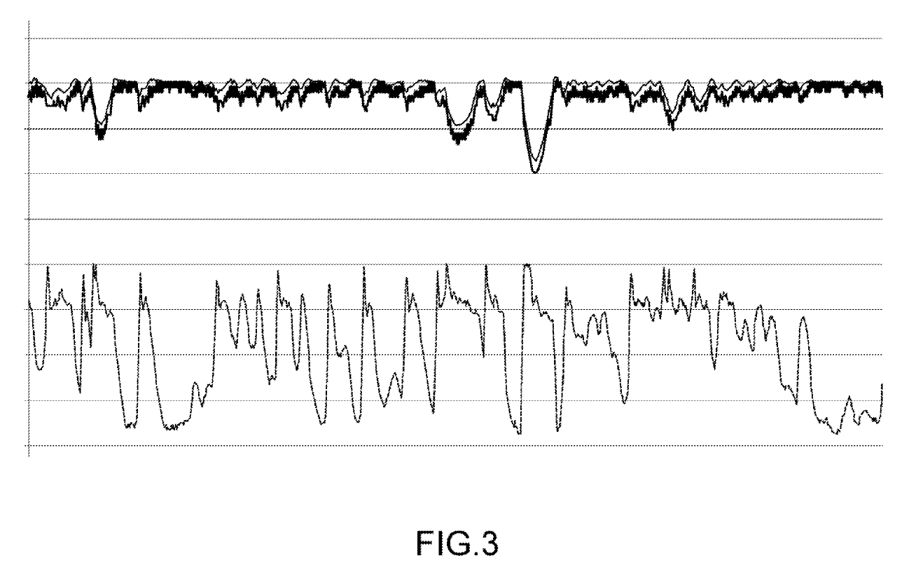

FIG. 3 shows the three same curves of FIG. 2, but in which the method of the disclosure is applied, the upper curve showing the speed of the motor, the curve that is closest to this curve shows the speed of the rotor, such that one can see that the rotor maintains its oscillations, and the speed of the motor accompanies said oscillations (thus, from this figure we can deduce that the sliding of the clutch is controlled and limited, since both speeds are closer to one another). The lower curve shows the motor torque, and it can be seen how the motor reduces the movements in which it works at the maximum demand with respect to the corresponding curve of FIG. 2, and as such, the motor works at an optimized load and therefore the duration of the useful life of the motor is greater, in addition to the fact that the intervals between maintenance can be longer with respect to the motor of FIG. 2.

The method for optimizing the load of a motor during a shredding process in a metal shredder object of the disclosure in the preferred embodiment of the same comprises the following steps:
measuring the speed of the rotor by means of at least one sensor,
calculating the modified speed, increasing the measured speed of the rotor, and
applying the calculated speed to the motor, such that the speed of the motor is the speed of the rotor increased by a percentage that is between 3% and 10%.

With the method object of the disclosure the motor load is optimized during the shredding process in a continuous way, meaning the control of the speed of the rotor and the modification of the speed of the motor is continuous during the shredding process, this way, the speed of the motor is adjusted to the speed of the rotor at all times as the motor demands more or less torque in order to shred the materials that are inside the shredding chamber of the shredder.

Due to the design thereof, each motor has its own torque curve that shows the torque offered by the motor as a function of the rotational speed of the motor itself. From a study of this torque curve, in the design phase it is decided which speeds are acceptable for the motor to work at for said application. If taking the motor of FIG. 1 as an example, and it has a nominal working speed of 1800 r/min, the speed of the motor can be reduced when necessary, but not below approximately 1050 r/min, since below this speed the torque obtained from the motor is less than the initial torque of the design.

We can define that the speeds at which we want the motor to work are those at which the torque supplied by the motor is no less than the nominal functioning torque at the normal speed regime (1800 r/min in FIG. 1). For example, according to FIG. 1, at 1800 r/min of the motor, the same provides approximately 890 Nm, and the speed could be reduced in this motor to approximately 1050 r/min.

Thus, to optimize the motor load, it is recommended that the motor work in the previously established speed range, both for making the best use of the motor and for maintenance of the same, since with the method object of the disclosure, the motor of the shredder always works at a speed within the best operating range of the same. This way, the problems of wear and possible malfunctioning are reduced with respect to motors that work at varying speeds.

As such, in the method object of the disclosure, the speed calculated based on the measured speed of the rotor, in other words, the speed that is applied to the motor of the shredder, is within the speed range of the motor which, within the torque curve of the motor, is within the area of the aforementioned curve where the motor torque is maintained between values that are previously established in the design phase.

With this condition, the operation of the shredder is completely optimized, given that the beginning of the operation of the hydraulic clutch establishes that the output torque and the input torque are maintained in their entirety.

With the speed modification of the motor we ensure a controlled sliding in the clutch for transmitting the operating torque of the design of the motor, avoiding a degree of power that the clutch could not transmit without sliding and thereby preventing additional heat from being generated by an excessive sliding of the clutch.

Thus, the method object of the disclosure carries out a dual control of the optimum speed of the motor of the shredder, since it controls for both the maximum sliding of the clutch and for torque demanded from the motor.

Considering the foregoing points, there are two situations in which either the control by sliding or control by torque demanded predominates. Said situations are:
if the torque the clutch is able to transmit is greater than the torque the motor can provide, meaning the clutch is overdimensioned with respect to the motor, the control that predominates is that of the motor torque. The control method object of the disclosure makes it so the speed of the motor is adjusted to speed at which motor torque is comprised within the values established in the design phase. In addition to this fact, if the product of the torque multiplied by the speed (power) makes the motor work at 100%, the speed is reduced to lower the percentage, as long as we are in the speed range established in the design phase.
if the torque the clutch can transmit is less than the torque the motor can provide, the control that predominates is that of sliding. In this case, the motor will not provide the maximum torque allowed, in order to prevent a greater sliding. The control method object of the disclosure makes it so the speed of the motor is reduced so as to limit the sliding, given that above a specific sliding the clutch will not transmit more torque and the extra power the motor would provide with more sliding would be lost in the form of heat.

With the method object of the disclosure, the following advantages are obtained:
less dissipation of heat due to the sliding, which demands less use of the cooling system of the hydraulic fluid of the clutch, both in the power intended for such effect, and with regard the necessary size of the systems (radiator, fan, etc.)
fewer maximum points of demand in the motor load, which extends the life of the motor in this application, and the range of operation of the motor is more effective.
greater intervals between maintenance operations for the motor, due to the fact that it works in a much more controlled fashion.
greater efficiency of general actuation.
better quality of the final shredded product, given the fact that the motor is not overloaded, which allows the feeding of the material to be more constant and the rotor to be able to work for the longest possible time with material inside the shredding chamber instead of working in a discontinuous way.

The disclosure is not intended to be limited to the specific embodiment described in this document. Those skilled in the art may develop other embodiments in light of the description made herein. As such, the scope of the disclosure is defined by the following claims.

1. A method for optimizing a motor load during a shredding process performed by a shredder of metal materials, the shredder of metal materials comprising a rotor of a shredding mill and a motor including a hydraulic clutch that relates the rotor to the motor, the method comprising:
A. measuring a speed of the rotor of the shredding mill with at least one sensor situated on the rotor of the shredding mill;
B. calculating a modified speed based on the speed measured in step A, based on a hydraulic sliding of the hydraulic clutch and a torque curve of the motor, wherein the modified speed provides a torque that is no less than a torque provided in a normal speed regime according to the design of the motor;
C. applying the modified speed to the motor of the shredder, and obtaining a rotational speed that optimizes the motor load during the shredding process.

2. The method for optimizing a motor load during a shredding process performed by a shredder of metal materials according to claim 1, wherein in the step of calculating a modified speed based on the speed measured in step A, the modified speed calculated is the speed of the rotor increased by 3% to 10%.
